(19) United States
(12) Patent Application Publication
(10) Pub. No.: US 2026/0214754 A1
(43) Pub. Date: Jul. 23, 2026

(54) DISPENSING BOTTLE WITH HEATING ASSEMBLY

(71) Applicant: SHENZHEN NUON MEDICAL EQUIPMENT CO., LTD., Shenzhen (CN)

(72) Inventors: Alain Dijkstra, Amstelveen (NL); Li Xiang, Shenzhen (CN)

(73) Assignee: Shenzhen Nuon Medical Equipment Co., Ltd., Shenzhen (CN)

(21) Appl. No.: 19/452,861

(22) Filed: Jan. 19, 2026

(30) Foreign Application Priority Data
Jan. 23, 2025 (CN) 2025201643859

(51) Int. Cl. H05B 3/02; A47K 5/12

(52) U.S. Cl. CPC H05B 3/02; A47K 5/1205

(57) ABSTRACT

Embodiments of the present invention disclose a dispensing bottle comprising a bottle body configured to store a care product, a bottle cap connected to the bottle body, a dispensing assembly disposed on the bottle cap, a heating assembly, and a phototherapy unit. The heating assembly includes a heat-conducting tube having a capillary wick on an inner wall thereof and containing a coolant. The heat-conducting tube has an evaporation end disposed adjacent to the bottle cap and a condensation end extending into the bottle body. A heating element is disposed on the evaporation end to heat the coolant, causing evaporation and subsequent condensation at the condensation end to transfer heat to the care product. The condensation end may be spiral-shaped and wound around a suction tube of the dispensing assembly. The dispensing bottle enables rapid and efficient heating of care products before dispensing while maintaining a compact and portable configuration.

### TECHNICAL FIELD

The present invention relates to the field of nursing and personal care equipment, and more particularly to a dispensing bottle with an integrated heating assembly, suitable for heating and dispensing care products such as skincare liquids, serums, essential oils, or medical nursing products.

### BACKGROUND ART

Traditionally, care and nursing products such as essential oils, serums, lotions, and medicinal liquids are stored in bottles and applied directly at ambient temperature. In order to enhance absorption, efficacy, or user comfort, these products are often heated prior to use. Conventional heating methods typically involve placing the entire product container in external heating devices, such as water baths, electric warmers, or dedicated heating boxes. In some cases, users may rely on improvised methods, including soaking bottles in warm water or using bulky countertop heaters, to raise the temperature of the product before application.

However, these traditional heating approaches suffer from several drawbacks. Heating the entire bottle requires a significant amount of time, even though only a small quantity of the product is needed for each use, resulting in inefficiency and poor user experience. External heating devices are generally large, inconvenient to carry, and unsuitable for travel or on-the-go use. Additionally, repeated heating of the entire product volume may degrade the quality or stability of temperature-sensitive care products. Moreover, existing dispensing bottles typically lack integrated heating functionality, requiring users to transfer products between containers or perform multiple steps, which increases complexity and the risk of contamination or spillage.

Various attempts have been made in the prior art to address the need for temperature-controlled dispensing of care products. For example, some cosmetic containers have been developed with integrated cooling devices that utilize refrigerant vaporization to cool cosmetics before dispensing. Such cooling systems typically include a separate refrigerant container, a refrigerant valve cylinder, and a vaporization tube surrounding the cosmetic suction tube, enabling the cosmetic to be cooled by the vaporization of the refrigerant before discharge. However, these cooling-based approaches require separate refrigerant containers and complex vaporization systems, which may increase structural complexity and manufacturing cost. Additionally, some prior art solutions have proposed heatable essence dropper bottle caps that include a heating sleeve disposed on the outer surface of a dropper, with metal contacts inside the dropper and at the bottom of the bottle body that are electrically connected through the essence liquid itself. A battery disposed in a base at the bottom of the bottle provides power to the heating sleeve when the essence is drawn into the dropper. While such dropper-type heating systems may provide localized heating, they rely on direct electrical heating through the liquid product, which may have limitations for certain product types or viscosities. Furthermore, some cosmetic containers have been proposed with heating wires wound around a screw core disposed within a nozzle portion, such that the contents are warmed as they pass through the nozzle during discharge. Although such nozzle-based heating systems may warm the contents during dispensing, they typically only heat the product during the discharge process and may not provide uniform heating throughout the product volume. These prior approaches may also lack efficient phase-change heat transfer mechanisms that enable rapid and uniform heating of the care product before dispensing.

In addition to the above approaches, the conventional solution also uses direct heating and instant heating methods for warming care products. In the direct heating approach, a heating element directly contacts or heats the liquid product, have been proposed in various forms. For example, some heatable dropper bottle caps utilize metal contacts disposed inside the dropper and at the bottom of the bottle body that are electrically connected through the liquid product itself, such that when the liquid is drawn into the dropper, the circuit is completed and a heating sleeve on the dropper is activated. While such direct heating approaches may provide localized heating, they rely on electrical conductivity of the liquid product, which may have limitations for certain product types, viscosities, or formulations that do not conduct electricity effectively. Furthermore, direct heating through the liquid may not provide uniform heating throughout the product volume, as the heating effect may be concentrated near the contact points.

Instant heating approaches, in which heating occurs only during the discharge or dispensing process, have also been proposed. For example, some cosmetic containers include heating wires wound around a screw core disposed within a nozzle portion, such that the contents are warmed as they pass through the nozzle during discharge. Although such instant heating systems may warm the contents during dispensing, they typically only heat the product during the brief discharge process and may not provide sufficient heating time for uniform temperature distribution throughout the dispensed product. The short contact time between the product and the heating element during discharge may result in inconsistent heating, particularly for products with higher viscosities or larger dispensing volumes. These direct heating and instant heating approaches in the prior art may also lack efficient phase-change heat transfer mechanisms that enable rapid and uniform heating of the care product before dispensing, and may not achieve the thermal efficiency provided by evaporation and condensation cycles within a sealed heat-conducting structure.

As a result, there exists a clear gap in the market for a compact, portable, and efficient solution that can selectively heat care products while simultaneously enabling precise and hygienic dispensing. Specifically, there is a need for a dispensing system that can rapidly heat only the required amount of the product, minimize waiting time, reduce energy consumption, and eliminate the reliance on external heating devices, while maintaining a user-friendly and travel-friendly form factor.

The present invention addresses this unmet need by providing a dispensing bottle with an integrated heating assembly. The invention combines a dispensing mechanism and a heating system within the bottle cap, enabling care products stored in the bottle to be rapidly heated and dispensed as needed. By employing a heat-conducting structure that efficiently transfers heat to the product inside the bottle, the invention allows fast and localized heating without the need to warm the entire container. This integrated design significantly reduces heating time, improves energy efficiency, and enhances portability.

Accordingly, the dispensing bottle of the present invention effectively bridges the gap in the market by offering a compact, easy-to-carry, and multifunctional solution that integrates heating and dispensing into a single device. The invention improves user convenience, enhances product usability, and provides a superior user experience compared to conventional heating and dispensing methods, making it particularly suitable for modern personal care and nursing applications.

### OBJECTS OF THE INVENTION

Some of the objects of the invention are as follows:

An object of the present invention is to provide a dispensing bottle capable of storing, heating, and dispensing liquid products in a controlled manner, wherein the liquid products include skincare liquids, serums, essential oils, and medical nursing products.

Another object of the present invention is to provide a dispensing bottle incorporating a liquid dispensing assembly and a heating assembly, such that the liquid products can be rapidly heated before dispensing without requiring external heating devices.

A further object of the present invention is to provide a dispensing bottle having a heat-conducting pipe and a heating element configured to achieve efficient heat transfer through evaporation and condensation of a coolant, thereby enabling uniform and rapid heating of the liquid products.

Another object of the present invention is to provide a dispensing bottle configured to dispense the liquid products through a pump-based dispensing mechanism, enabling accurate dosage control and one-click dispensing.

Another object of the present invention is to provide a dispensing bottle having a compact and integrated structure in which the liquid dispensing assembly, heating assembly, battery, and circuit board are arranged within a bottle cap, thereby improving portability and ease of use.

A further object of the present invention is to provide a dispensing bottle that may include a phototherapy element configured to irradiate the liquid products before dispensing and/or provide phototherapy to a user’s skin after application of the liquid products.

Yet another object of the present invention is to provide a dispensing bottle that improves hygiene, convenience, and efficiency of use while reducing contamination risk and enhancing user experience in personal care and medical nursing applications.

### SUMMARY OF THE INVENTION

According to a first aspect of the present invention, a dispensing bottle with an integrated heating assembly for heating and dispensing a care product is provided. The dispensing bottle comprising: a bottle body configured to store a care product; a bottle cap connected to the bottle body; a dispensing assembly disposed on the bottle cap and configured to dispense the care product from the bottle body; a heating assembly including a heat-conducting tube and a heating element, wherein: an inner wall of the heat-conducting tube is provided with a capillary wick; a coolant is disposed inside the heat-conducting tube; the heat-conducting tube has an evaporation end and a condensation end; the evaporation end is connected to a side of the bottle cap adjacent to the bottle body; the condensation end extends into the bottle body; and the heating element is disposed on the evaporation end; and wherein the heating assembly is configured to heat a dispensing portion of the care product proximate to the condensation end by enabling rapid and continuous heat transfer through evaporation and condensation.

In one embodiment of the present invention, the condensation end is spiral-shaped and the heating element is wound around the evaporation end.

In one embodiment of the present invention, the dispensing assembly includes a suction tube extending into the bottle body, and the condensation end is wound around the suction tube.

In one embodiment of the present invention, the dispensing assembly comprises: a dispensing pump core disposed inside the bottle cap; a suction tube having one end connected to one end of the dispensing pump core and another end passing through the bottle cap on a side adjacent to the bottle body into the bottle body; a connecting tube having one end connected to another end of the dispensing pump core and another end passing through the bottle cap on a side away from the bottle body to an outside of the bottle cap; and a press-to-dispense head connected to the other end of the connecting tube.

In one embodiment of the present invention, the bottle cap comprises: an outer casing having a connection port on a side adjacent to the bottle body, wherein the connecting tube passes through the outer casing on a side away from the connection port; and a connecting seat connected to the connection port to form a receiving cavity between the outer casing and the connecting seat, wherein the receiving cavity accommodates the dispensing pump core, and the connecting seat is configured to connect to the bottle body; wherein the suction tube passes through the connecting seat, the evaporation end is disposed in the receiving cavity, and the condensation end passes through the connecting seat into the bottle body.

In one embodiment of the present invention, the bottle body is provided with a bottle mouth; the connecting seat includes a top wall having an opening, a peripheral wall connected to an edge of the top wall and configured to surround and connect to the bottle mouth, and a flange connected to an edge of the peripheral wall away from the top wall and configured to connect to the connection port; and the bottle cap further includes a sealing ring comprising a main body connected to the opening and a sealing part connected to the main body and configured to clamp between the top wall and an end face of the bottle mouth, wherein the suction tube and the heat-conducting tube pass through the main body and the bottle mouth.

In one embodiment of the present invention, the sealing ring further includes a limiting part connected to a side of the main body facing away from the sealing part, the limiting part being disposed in the receiving cavity, the limiting part being provided with a limiting channel and a limiting groove, wherein one end of the suction tube is connected to one end of the dispensing pump core in the limiting channel, and the heating element and the evaporation end are disposed in the limiting groove.

In one embodiment of the present invention, the dispensing assembly further includes a fixing member connected to an inner wall of the outer casing on a side away from the connection port and connected to the dispensing pump core.

In one embodiment of the present invention, the dispensing bottle further comprises a battery and a circuit board disposed within the bottle cap, the circuit board being electrically connected to the heating element and the battery to control heating operation.

In one embodiment of the present invention, the dispensing bottle further includes a touch key and a charging electrode electrically connected to the circuit board, wherein the touch key is disposed on the bottle cap and configured to control an operating state of the heating element, and the charging electrode is disposed on the touch key and configured to charge the battery.

In one embodiment of the present invention, the bottle cap further comprising a temperature sensor configured to automatically activate or deactivate the heating element based on the detected temperature relative to a predetermined reference temperature.

According to a second aspect of the invention, a bottle cap with an integrated heating assembly and dispensing assembly for attachment to a bottle body storing a care product is provided. The bottle cap comprising: an outer casing having a connection port on a side adjacent to the bottle body, and a connecting seat connected to the connection port to form a receiving cavity between the outer casing and the connecting seat; a dispensing assembly including a dispensing pump core disposed in the receiving cavity, a suction tube having one end connected to the dispensing pump core and another end extending through the connecting seat into the bottle body, a connecting tube having one end connected to the dispensing pump core and another end extending through the outer casing to an outside of the bottle cap, and a press-to-dispense head connected to the connecting tube; a heating assembly including a heat-conducting tube having an evaporation end disposed in the receiving cavity and a condensation end extending through the connecting seat into the bottle body, wherein an inner wall of the heat-conducting tube is provided with a capillary wick and a coolant is disposed inside the heat-conducting tube, and a heating element disposed on the evaporation end; wherein the heating assembly is configured to heat a dispensing portion of the care product proximate to the condensation end by enabling rapid and continuous heat transfer through evaporation and condensation; and wherein the bottle cap is configured to connect to a bottle body storing the care product.

In one embodiment of the present invention, the condensation end is spiral-shaped and wound around the suction tube.

In one embodiment of the present invention, the heating element is spiral-shaped and wound around the evaporation end.

In one embodiment of the present invention, the connecting seat includes a top wall having an opening, a peripheral wall connected to an edge of the top wall and configured to surround and connect to the bottle mouth, and a flange connected to an edge of the peripheral wall away from the top wall and configured to connect to the connection port; and the bottle cap further includes a sealing ring comprising a main body connected to the opening and a sealing part connected to the main body and configured to clamp between the top wall and an end face of the bottle mouth, wherein the suction tube and the heat-conducting tube pass through the main body and the bottle mouth.

In one embodiment of the present invention, the sealing ring further includes a limiting part connected to a side of the main body facing away from the sealing part, the limiting part being disposed in the receiving cavity and provided with a limiting channel and a limiting groove, wherein one end of the suction tube is connected to one end of the dispensing pump core in the limiting channel, and the heating element and the evaporation end are disposed in the limiting groove.

In one embodiment of the present invention, the dispensing bottle further comprising a battery and a circuit board disposed in the bottle cap, the circuit board being electrically connected to the heating element and the battery, and a touch key disposed on the bottle cap and electrically connected to the circuit board, the touch key being configured to control an operating state of the heating element.

In one embodiment of the present invention, the bottle cap further comprising a phototherapy unit configured to provide phototherapy to a user.

According to a third aspect of the present invention, a method of dispensing and heating a care product using a dispensing bottle having a heat-conducting tube with a capillary wick is provided. The method comprising: storing the care product in a bottle body of a dispensing bottle; activating a heating element disposed on an evaporation end of a heat-conducting tube, wherein the heat-conducting tube includes a capillary wick on an inner wall thereof and contains a coolant, and wherein a condensation end of the heat-conducting tube extends into the bottle body; transferring heat from the evaporation end to the condensation end via evaporation and condensation of the coolant within the heat-conducting tube to heat a dispensing portion of the care product in the bottle body; dispensing the heated dispensing portion of the care product through a dispensing assembly disposed on a bottle cap connected to the bottle body.

In one embodiment of the present invention, the condensation end of the heat-conducting tube is spiral-shaped and wound around a suction tube of the dispensing assembly that extends into the bottle body.

In one embodiment of the present invention, transferring heat from the evaporation end to the condensation end comprises: evaporating the coolant at the evaporation end responsive to heat from the heating element; moving the evaporated coolant toward the condensation end; condensing the evaporated coolant at the condensation end to release heat to the dispensing portion of the care product; and returning the condensed coolant to the evaporation end via capillary action of the capillary wick.

In one embodiment of the present invention, the dispensing bottle further comprises a temperature sensor disposed within the bottle cap and electrically connected to the circuit board. The circuit board may include a control unit configured to automatically activate or deactivate the heating element based on a detected temperature relative to a predetermined reference temperature.

In one embodiment of the present invention, the circuit board is configured to provide multiple selectable heating modes or power levels, and may store preset temperature profiles corresponding to different care product types. The dispensing bottle may further include a timer function configured to automatically deactivate the heating element after a predetermined heating duration.

In one embodiment of the present invention, the dispensing bottle further comprises one or more indicator elements disposed on the bottle cap and electrically connected to the circuit board, the indicator elements being configured to provide visual feedback indicating an operating state of the heating element, a battery charge level, or a completion of a heating cycle.

In one embodiment of the present invention, the capillary wick is formed from a material selected from sintered metal powder, metal mesh, grooved structures, fiber wicks, ceramic wicks, or combinations thereof.

In one embodiment of the present invention, the coolant disposed inside the heat-conducting tube is selected from water, alcohol, acetone, or other volatile fluids having relatively low boiling points and being non-toxic.

In one embodiment of the present invention, the suction tube is formed from a thermally conductive material including copper, aluminum, stainless steel, or alloys thereof, and the outer surface of the suction tube or the condensation end may be provided with fins or heat transfer enhancement structures.

In one embodiment of the present invention, the bottle body is formed from glass, plastic, including polyethylene terephthalate, high-density polyethylene, or polypropylene, and may include ultraviolet blocking properties to protect light-sensitive care products.

In one embodiment of the present invention, thermal insulation is disposed between the heating assembly and the outer casing of the bottle cap to reduce heat loss and prevent the exterior surface from becoming uncomfortably hot during operation.

In one embodiment of the present invention, the dispensing bottle includes safety features comprising automatic shut-off after a predetermined time period, overheat protection, low battery warning, or child-lock functionality.

In one embodiment of the present invention, the dispensing bottle further comprises an inductive charging coil disposed within the bottle cap and electrically connected to the circuit board and the battery for wireless charging.

In one embodiment of the present invention, the dispensing assembly is configured to provide adjustable dispensing volume control, and the bottle cap assembly is configured to be compatible with multiple interchangeable bottle bodies having different sizes or capacities.

In one embodiment of the present invention, the dispensing bottle further comprises a vibration element disposed within the bottle cap and configured to provide massage stimulation to the user's skin during or after application of the care product.

In one embodiment of the present invention, the dispensing bottle further comprises one or more microcurrent electrodes disposed on an exterior surface of the bottle cap and configured to deliver low-level electrical current to the user's skin to enhance absorption of the care product.

In one embodiment of the present invention, the dispensing bottle further comprises a cooling element disposed within the bottle cap and configured to provide cooling therapy to the user's skin after application of the care product.

In one embodiment of the present invention, the dispensing bottle further comprises an ultrasonic transducer disposed within the bottle cap and configured to generate ultrasonic vibrations to enhance penetration of the care product into the user's skin.

In one embodiment of the present invention, the dispensing bottle comprises multiple stimulation elements configured to operate in combination, and the circuit board is configured to control the multiple stimulation elements simultaneously or sequentially according to a predetermined treatment program.

In one embodiment of the present invention, the phototherapy element is disposed on an exterior surface of the bottle cap and comprises one or more light-emitting diodes configured to emit light at wavelengths suitable for skin treatment, including red light for collagen stimulation, blue light for antibacterial treatment, or near-infrared light for enhanced absorption of the care product.

The dispensing bottle and method provided by the present invention enable efficient heating, controlled dispensing, and phototherapy treatment of care products, while maintaining a compact structure, simplified operation, and improved user experience.

In the context of the specification, when an element is referred to as being “fixed to” or “disposed to” another element, it may either be directly on another element or indirectly on that other element. When a component is said to be “connected” or “connected to” another component, it may be directly connected to another component or indirectly connected to other components on the piece.

In the context of the specification, the terms “first”, “second,” and “third” are only used for descriptive purposes and do not imply the relative importance or implicitly indicate the quantity of technical features indicated.

In the context of the specification, the term “plurality” means two or more than two, unless otherwise indicated.

In the context of the specification, the term "several" means more than one, unless otherwise specified.

In the context of the specification, the term "beauty device", "therapy device", or "physiotherapy device" refers to the device of the present invention configured to perform atomization, phototherapy, thermal therapy, or combined treatment.

In the context of the specification, the term "stimulation element" refers broadly to any component, module, or structure configured to apply a therapeutic or cosmetic stimulus to a user's skin or tissue. Stimulation elements may include, but are not limited to, phototherapy elements, massage elements, microcurrent electrodes, ultrasonic transducers, heating elements, cooling elements, or combinations thereof.

In the context of the specification, the term "phototherapy element" encompasses any light-emitting device capable of emitting light of therapeutic wavelength(s), including but not limited to light-emitting diodes (LEDs), organic LEDs (OLEDs), laser diodes, or equivalent optical sources. The light may include ultraviolet, visible, near-infrared, or far-infrared spectra.

In the context of the specification, the term "massage element" refers to any component adapted to apply mechanical stimulation to the skin, including rotating rollers, kneading members, vibrating members, or reciprocating structures. The massage element may be fixed, detachable, or mounted for rotation or vibration relative to the housing.

In the context of the specification, the term "microcurrent element" refers to any electrode or conductive structure configured to deliver a controlled electrical signal to the user's skin. Such elements may include paired electrodes, conductive surfaces, or pads connected to a circuit board for generating microcurrent, galvanic current, or equivalent electrical therapy.

In the context of the specification, the term "housing" is intended to cover any casing, enclosure, or structural body that contains or supports components of the device. The housing may include a handle portion, head portion, or other segments, and may be made from polymeric, metallic, composite, or other suitable materials.

In the context of the specification, the term "liquid container," "liquid storage chamber," or "reservoir" refers to a chamber or container configured to hold liquid for atomization.

In the context of the specification, the term "heating element," "temperature control element," or "thermal element" refers to any suitable device or structure for heating or cooling the treatment surface or liquid.

In the context of the specification, the term "light-emitting element," "phototherapy component," or "light-transmitting surface" refers to a component configured to emit light for skin treatment.

In the context of the specification, the term "mounting part," "mounting groove," or "mounting housing" refers to a structure configured to hold, position, or support the atomizing module.

In the context of the specification, the term "sealing pad," "retaining ring", or "gasket" refers to a component configured to provide a sealed connection between structural elements, preventing liquid or mist leakage.

In the context of the specification, the term "dispensing portion" refers to the portion of the care product that is located within the limited space defined between the condensation end of the heat-conducting tube and the suction tube, and which is proximate to the suction tube for drawing into the dispensing assembly. The dispensing portion represents a predetermined or limited volume of the care product that is heated by the heating assembly before being dispensed, rather than the entire contents of the bottle body.

In the context of the specification, the term "LED module" refers to one or more light-emitting diode (LED) elements that are electrically connected and configured to emit light of specific wavelengths suitable for therapeutic purposes. The LED module may include drive circuitry, heat dissipation structures, and optical elements such as lenses or diffusers to control light distribution.

In the context of the specification, the term "light source" or "phototherapy source" etc. refers to a source emitting coherent laser light, or light-emitting diodes ("LEDs"). The term "light therapy" refers to light generated from any of the sources, such as lasers, LED sources, or Super luminous diodes ("SLD").

In the context of the specification, "Light Emitting Diodes (LEDs)" refer to semiconductor diodes capable of emitting electromagnetic radiation when supplied with an electric current. The LEDs are characterized by superior power efficiencies, smaller sizes, rapid switching speeds, physical robustness, and longer lifespans compared to incandescent or fluorescent lamps. The one or more LEDs may include through-hole type LEDs (generally emitting electromagnetic radiation in red, green, yellow, blue, and white colors), Surface Mount Technology (SMT) LEDs, Bi-color LEDs, Pulse Width Modulated RGB (Red-Green-Blue) LEDs, and high-power LEDs, among others.

Materials used in one or more LEDs may vary from one embodiment to another, depending upon the frequency of radiation required. Different frequencies can be obtained from LEDs made from pure or doped semiconductor materials. Commonly used semiconductor materials include nitrides of Silicon, Gallium, Aluminum, Boron, Zinc Selenide, etc., in pure form or doped with elements such as Aluminum and Indium. For example, red and amber colors are produced from Aluminum Indium Gallium Phosphide (AlGaInP) based compositions, while blue, green, and cyan use Indium Gallium Nitride based compositions. White light may be produced by mixing red, green, and blue lights in equal proportions, while varying proportions may be used to generate a wider color gamut. White and other colored lightings may also be produced using phosphor coatings such as Yttrium Aluminum Garnet (YAG) in combination with a blue LED to generate white light, and Magnesium-doped potassium fluorosilicate in combination with a blue LED to generate red light.

In addition to conventional mineral-based LEDs, one or more LEDs may also be provided on an Organic LED (OLED) based flexible panel or an inorganic LED-based flexible panel. Such OLED panels may be generated by depositing organic semiconducting materials over Thin Film Transistor (TFT) based substrates. Further, a discussion on the generation of OLED panels can be found in Bardsley, J. N (2004), "International OLED Technology Roadmap", IEEE Journal of Selected Topics in Quantum Electronics, Vol. 10, No. 1, that is included herein in its entirety, by reference. An exemplary description of flexible inorganic light-emitting diode strips can be found in granted U.S. Pat. No. 7,476,557 B2, titled "Roll-to-roll fabricated light sheet and encapsulated semiconductor circuit devices", which is included herein in its entirety by reference.

Unless otherwise stated, the term "light" as used in this specification encompasses electromagnetic radiation in the visible (380–780 nm) and infrared (780 nm–1000 nm) ranges, particularly red light (620–750 nm) and near-infrared (750–1400 nm) wavelengths commonly used in photobiomodulation therapy. Particular wavelengths which may be selected as the dominant emissive wavelength may include the follow, without any preference to be indicated by order: 400 nm, 405 nm, 420 nm, 430 nm, 450 nm, 465 nm, 515 nm, 530 nm, 532 nm, 590 nm, 630 nm, 633 nm, 640 nm, 650 nm, 655 nm, 660 nm, 670 nm, 680 nm, 780 nm, 785 nm, 810 nm, 830 nm, 840 nm, 850 nm, 860 nm, 870 nm, 904 nm, 915 nm, 980 nm, 1015 nm, 1060 nm, 1065 nm, 1070 nm, 1200, and 1400 nm. As used herein, the term "light therapy" refers to the use of one or more light sources of any type that emit light with a wavelength between about 400 and 1400 nm. The device may also emit blue or ultraviolet light for surface-level treatments such as acne reduction or microbial control.

The red light (approximately 630–660 nm) penetrates deeply into the scalp to stimulate blood circulation and enhance hair follicle activity, thus promoting hair growth and repair. Blue light (around 415–470 nm) exhibits antibacterial properties and is effective in treating scalp acne and reducing inflammation. Green light (approximately 520–540 nm) can help reduce pigmentation and soothe sensitive or irritated scalp tissue. Yellow light (around 580–600 nm) improves oxygen exchange in the cells and aids in detoxifying the scalp, while near-infrared light (800–850 nm) reaches deeper layers to accelerate healing and reduce pain.

### BRIEF DESCRIPTION OF THE ACCOMPANYING DRAWINGS

The accompanying drawings illustrate the best mode for carrying out the invention as presently contemplated and set forth hereinafter. The present invention may be more clearly understood from a consideration of the following detailed description of the preferred embodiments taken in conjunction with the accompanying drawings, wherein like reference letters and numerals indicate the corresponding parts in various figures in the accompanying drawings, and in which:

FIG. 1 shows a perspective view of a dispensing bottle, in accordance with an embodiment of the present invention.

FIG. 2 is an exploded view of a bottle body and a bottle cap of the dispensing bottle, in accordance with an embodiment of the present invention.

FIG. 3 shows a cross-sectional view of the dispensing bottle, in accordance with an embodiment of the present invention.

FIG. 4 shows an exploded view of the dispensing bottle, in accordance with an embodiment of the present invention.

FIG. 5 is a perspective view of a heat pipe, depicting a condensation end and an evaporation end, in accordance with an embodiment of the present invention.

FIG. 6 is a partial cross-sectional view of the heat pipe, in accordance with an embodiment of the present invention.

### DETAILED DESCRIPTION

Embodiments of the present invention disclosure will be described more fully hereinafter with reference to the accompanying drawings in which like numerals represent like elements throughout the figures, and in which example embodiments are shown.

The detailed description and the accompanying drawings illustrate the specific exemplary embodiments by which the disclosure may be practiced. These embodiments are described in detail to enable those skilled in the art to practice the invention illustrated in the disclosure. It is to be understood that other embodiments may be utilized, and other changes may be made, without departing from the spirit or scope of the present disclosure. The following detailed description is therefore not to be taken in a limiting sense, and the scope of the present invention disclosure is defined by the appended claims. Embodiments of the claims may, however, be embodied in many different forms and should not be construed as limited to the embodiments set forth herein.

The terms “a” and “an” herein do not denote a limitation of quantity, but rather denote the presence of at least one of the referenced items. The terms “having”, “comprising”, “including”, and variations thereof signify the presence of a component.

Embodiments of the present invention relate to a liquid dispensing system with integrated heating, which is implemented in the form of a dispensing bottle. The dispensing bottle comprises a bottle body for storing medical or care products, a bottle cap connected to the bottle body, a liquid dispensing assembly disposed on the bottle cap, and a heating assembly. The heating assembly includes a heat-conducting pipe and a heating element, wherein an evaporation end of the heat-conducting pipe is disposed within the bottle cap, and a condensation end extends into the bottle body, such that the care products stored in the bottle body can be heated before dispensing.

The liquid dispensing assembly is configured to dispense the care products in a controlled manner through user operation, while the heating assembly enables rapid and efficient heating of the care products without requiring external heating equipment. By integrating the liquid dispensing assembly, the heating assembly, a battery, and a circuit board within the bottle cap, the dispensing bottle achieves a compact structure, convenient operation, and improved portability. The dispensing bottle allows users to obtain heated care products quickly and efficiently, making it particularly suitable for situations where care products need to be frequently used or dispensed.

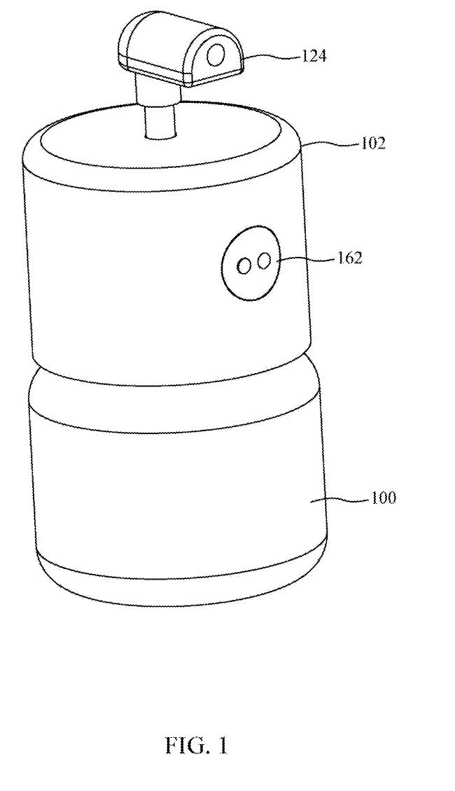

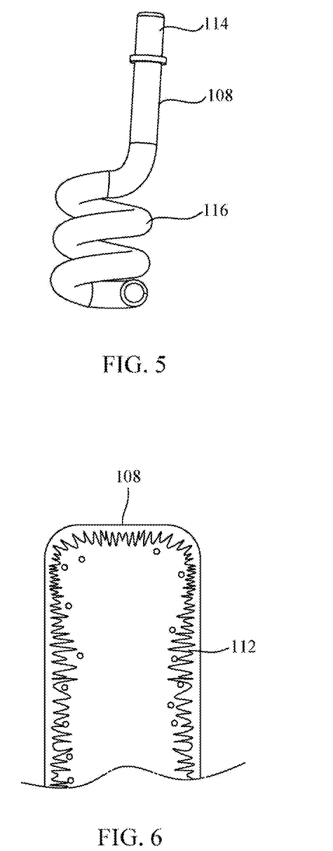

Referring to FIGS. 1 to 6, the present invention provides a dispensing bottle comprising a bottle body 100, a bottle cap 102, a liquid dispensing assembly 104, and a heating assembly 106. The bottle body 100 is configured to store medical, nursing, or care products. The bottle cap 102 is detachably connected to the bottle body 100 and is configured to close and seal the bottle body 100. The liquid dispensing assembly 104 is disposed on the bottle cap 102 and is configured to dispense the medical products stored within the bottle body 100. The heating assembly 106 comprises a heat-conducting pipe 108 and a heating element 110.

The inner wall of the heat-conducting pipe 108 is provided with a capillary wick 112, and a coolant is contained within the heat-conducting pipe 108. The heat-conducting pipe 108 includes an evaporation end 114 and a condensation end 116. The evaporation end 114 is disposed on a side of the bottle cap 102 adjacent to the bottle body 100, while the condensation end 116 extends into the interior of the bottle body 100. The heating element 110 is arranged on the evaporation end 114 of the heat-conducting pipe 108. The heating assembly 106 is configured to transfer heat to a dispensing portion of the care product stored in the bottle body 100.

In an embodiment, the bottle body 100 functions as a primary storage container for care products such as essential oils, serums, lotions, or similar liquid medical or nursing products, thereby ensuring safe and hygienic storage. The bottle cap 102 not only provides a sealing function for the bottle body 100 but also integrates the liquid dispensing assembly 104 and the heating assembly 106 into a single structural unit, resulting in a compact configuration and enhanced portability of the dispensing bottle.

The liquid dispensing assembly 104 is configured to control the flow and quantity of the care product dispensed, enabling accurate and controlled delivery of a desired dosage. The heating assembly 106 utilizes the heat-conducting pipe 108 to achieve efficient heat transfer. Specifically, the capillary wick 112 is provided on the inner wall of the heat-conducting pipe 108, which facilitates circulation of the coolant within the pipe, thereby enabling rapid heat conduction.

During operation, the heating element 110 heats the evaporation end 114 of the heat-conducting pipe 108, causing the coolant therein to evaporate. The generated vapour transfers heat toward the condensation end 116, which extends into the bottle body 100, thereby heating the dispensing portion of the care product contained therein. The coolant subsequently condenses and returns to the evaporation end 114 through capillary action of the capillary wick 112, thereby forming a continuous heat transfer cycle. The heating element 110 may be implemented in various forms, including but not limited to a heating wire, a heating rod, or a heating plate, without departing from the scope of the present invention.

Specifically, the interior of the heat-conducting pipe 108 is evacuated to a negative pressure state and is filled with a suitable coolant. The coolant is highly volatile and selected to have a relatively low boiling point, thereby facilitating efficient phase-change heat transfer. When the heating element 110 applies heat to the evaporation end 114 of the heat-conducting pipe 108, the coolant located at the evaporation end 114 rapidly absorbs thermal energy and vaporizes. The generated vapour, driven by a temperature gradient and pressure difference, rapidly flows toward the condensation end 116 of the heat-conducting pipe 108.

Upon reaching the condensation end 116, the vapour releases thermal energy to the dispensing portion of the care product contained within the bottle body 100, thereby heating the dispensing portion. Following heat release, the vapour condenses back into a liquid state at the condensation end 116. The condensed coolant is then transported back to the evaporation end 114 through capillary action provided by the capillary wick 112, which is disposed on the inner wall of the heat-conducting pipe 108, thereby forming a closed-loop heat transfer cycle. This phase-change heat transfer process occurs rapidly, enabling fast and efficient heating of the dispensing portion of the care product.

In some embodiments, the capillary wick disposed on the inner wall of the heat-conducting tube may be formed from various materials suitable for facilitating capillary action and coolant transport. Suitable capillary wick materials may include, but are not limited to, sintered metal powder, metal mesh or screen, grooved structures formed on the inner wall of the heat-conducting tube, fiber wicks, ceramic wicks, or combinations thereof. The capillary wick may be formed integrally with the heat-conducting tube or may be disposed as a separate layer on the inner wall of the heat-conducting tube. In some aspects, the capillary wick may be formed by sintering metal powder (such as copper or stainless-steel powder) onto the inner surface of the heat-conducting tube to create a porous structure with high capillary pressure. In other aspects, the capillary wick may comprise a fine metal mesh or woven screen that is inserted into and contacts the inner wall of the heat-conducting tube. The selection of the capillary wick material and structure may be based on factors including porosity, capillary pressure, permeability, thermal conductivity, and compatibility with the selected coolant. The capillary wick is configured to transport condensed coolant from the condensation end back to the evaporation end through capillary action, thereby enabling continuous circulation of the coolant within the heat-conducting tube and sustained heat transfer operation.

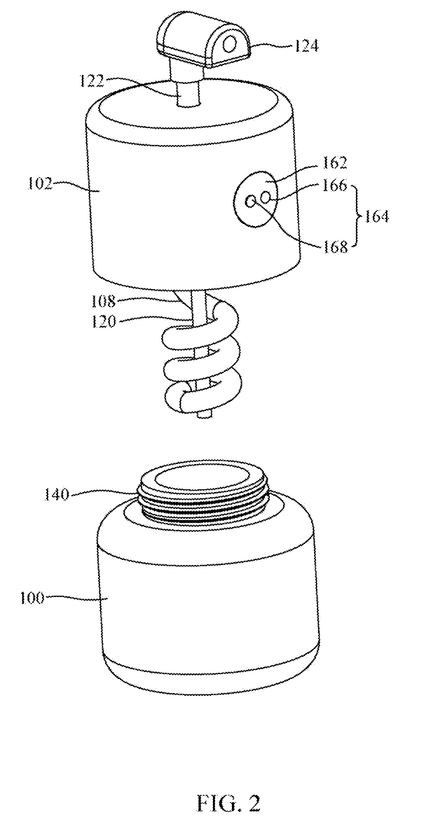

Referring to FIGS. 2 to 5, in an embodiment, the condensation end 116 of the heat-conducting pipe 108 is configured to have a spiral shape. The spiral configuration significantly increases the surface area of the condensation end 116 that is in contact with the dispensing portion of the care product stored within the bottle body 100. Compared to a straight pipe configuration, the spiral structure provides an enlarged heat exchange area, thereby improving heat transfer efficiency, enabling faster heating of the dispensing portion, and enhancing the overall user experience.

Referring to FIGS. 2 to 4, in an embodiment, the liquid dispensing assembly 104 includes a suction tube 120 that extends into the bottle body 100, and the condensation end 116 of the heat-conducting pipe 108 is wound around the suction tube 120. The suction tube 120 is configured to draw the care product from the bottle body 100 for dispensing to the user.

In this embodiment, the condensation end 116 of the heat-conducting pipe 108 is directly wound around the suction tube 120, allowing the suction tube 120 and the condensation end 116 to be jointly inserted into the bottle body 100 through a bottle mouth 140 as a single integrated assembly. This configuration reduces the number of separate installation steps, simplifies the assembly process, and ensures close physical contact between the condensation end 116 and the suction tube 120. Moreover, by integrating the condensation end 116 with the suction tube 120, the internal space within the bottle body 100 is utilized more efficiently, resulting in a compact and rational internal arrangement that supports miniaturization of the dispensing bottle.

Due to the close contact between the spirally wound condensation end 116 and the suction tube 120, thermal energy released by the coolant during condensation is efficiently transferred to the dispensing portion of the care product flowing within the suction tube 120. The increased contact area created by the winding configuration enhances heat exchange efficiency, allowing the dispensing portion to be heated rapidly as it is drawn toward the dispensing assembly. Consequently, the embodiments of the present application are capable of significantly reducing user waiting time and improving overall user experience.

In some embodiments, the space defined between the spirally wound condensation end and the suction tube may be configured to accommodate a limited or predetermined volume of the care product, referred to herein as dispensing portion. This configuration may enable the heating assembly to efficiently heat only the dispensing portion of the care product that is proximate to the condensation end and the suction tube, rather than heating the entire contents of the bottle body. By concentrating the heat transfer within this limited space surrounding the suction tube, the dispensing portion that will be drawn into the suction tube for dispensing may be rapidly and efficiently heated. This arrangement may improve energy efficiency, reduce heating time, and avoid repeated heating of the entire product volume, which may help preserve the quality and stability of temperature-sensitive care products.

In some embodiments, an insulation coating may be disposed on an outer surface of the spiral-shaped condensation end of the heat-conducting tube. The insulation coating may be configured to direct heat transfer inwardly toward the suction tube rather than outwardly to the surrounding liquid in the bottle body. By providing thermal insulation on the outer surface of the condensation end, the heat released during condensation of the coolant may be concentrated and transferred primarily to the dispensing portion of the care product flowing within the suction tube and to the limited space defined between the condensation end and the suction tube. This configuration may improve heating efficiency by focusing the heat transfer on the dispensing portion that will be drawn into the suction tube for dispensing, rather than dissipating heat to the bulk liquid stored in the bottle body. The insulation coating may be formed from various thermally insulating materials, including but not limited to polymeric coatings, ceramic coatings, or other suitable insulating materials that are compatible with the care product and the operating temperature range of the heating assembly.

In some embodiments, the dispensing assembly may be implemented in various forms besides the pump-based mechanism described above. Alternative dispensing mechanisms may include, but are not limited to, droppers, piston, squeeze bottles, spray mechanisms, roller applicators, or other suitable dispensing structures configured to deliver the care product from the bottle body to the user. The heat-conducting tube configuration with the insulation coating and spiral-shaped condensation end may be adapted for use with these alternative dispensing mechanisms. For example, in a dropper-type dispensing assembly, the condensation end of the heat-conducting tube may be wound around a dropper tube extending into the bottle body, such that the dispensing portion of the care product drawn into the dropper tube is heated before dispensing. In a squeeze bottle configuration, the condensation end may be disposed adjacent to a liquid delivery pathway leading to a dispensing outlet. The suction tube or liquid delivery pathway may be configured according to the specific dispensing mechanism employed, and the limited space defined between the condensation end and the liquid delivery pathway may similarly accommodate a predetermined volume of the care product (dispensing portion) for efficient localized heating. Accordingly, the heating assembly of the present invention is not limited to use with pump-based dispensing mechanisms and may be integrated with various dispensing configurations to provide heated care product delivery.

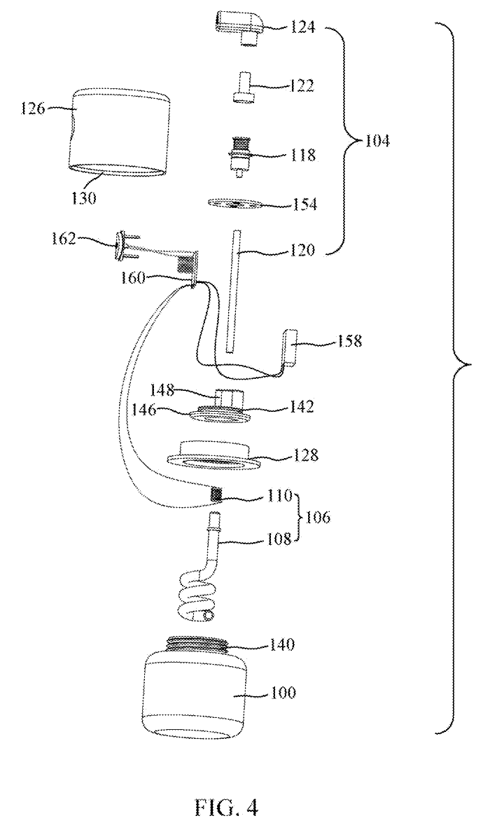

Referring to FIG. 4, the heating element 110 is configured to have a spiral shape and is wrapped around the evaporation end 114 of the heat-conducting pipe 108. This arrangement increases the contact area between the heating element 110 and the evaporation end 114, thereby improving heat transfer efficiency and further accelerating the heating process.

In this embodiment, the heating element 110 is configured in a spiral form and is wound around the evaporation end 114 of the heat-conducting pipe 108. By increasing the contact area between the heating element 110 and the evaporation end 114, thermal transfer efficiency is enhanced, thereby enabling rapid heating of the heat-conducting pipe 108. As a result, the time required to heat the care product is reduced, which shortens user waiting time and improves overall user experience.

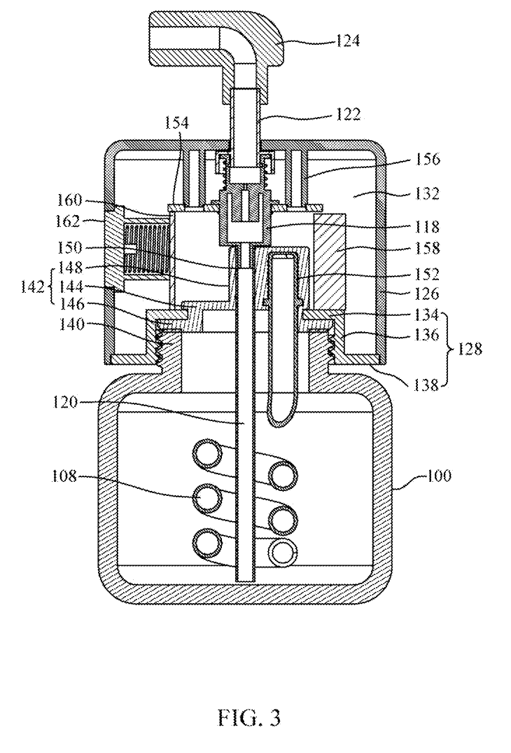

Referring to FIGS. 3 and 4, in an embodiment, the liquid dispensing assembly 104 comprises a liquid dispensing pump core 118, the suction tube 120, a connecting tube 122, and a press-to-dispense head 124. The liquid dispensing pump core 118 is disposed within the bottle cap 102. One end of the suction tube 120 is connected to a first end of the liquid dispensing pump core 118, while the other end of the suction tube 120 passes through a side of the bottle cap 102 adjacent to the bottle body 100 and extends into the interior of the bottle body 100. One end of the connecting tube 122 is connected to a second end of the liquid dispensing pump core 118, and the other end of the connecting tube 122 passes through a side of the bottle cap 102 away from the bottle body 100 and extends to the exterior of the bottle cap 102. The press-to-dispense head 124 is connected to the external end of the connecting tube 122.

In an embodiment, the liquid dispensing pump core 118 is mounted within the bottle cap 102 and functions as the driving component of the liquid dispensing assembly 104. The liquid dispensing pump core 118 is configured to draw the care product from the bottle body 100 via the suction tube 120 and deliver the care product outward through the connecting tube 122. The upper end of the suction tube 120 is connected to the lower end of the liquid dispensing pump core 118, while the lower end of the suction tube 120 extends toward the bottom region of the bottle body 100, thereby enabling effective extraction of the care product and reducing product residue.

The lower end of the connecting tube 122 is connected to the upper end of the liquid dispensing pump core 118, and the upper end of the connecting tube 122 extends through the top of the bottle cap 102 to the outside, thereby forming a liquid delivery passage for guiding the care product out of the bottle body 100. The press-to-dispense head 124 is disposed above the bottle cap 102 and is operable by a user. When the press-to-dispense head 124 is actuated, the liquid dispensing pump core 118 draws the care product from the bottle body 100 through the suction tube 120, conveys the care product through the connecting tube 122, and discharges the care product from the press-to-dispense head 124.

It will be understood that the liquid dispensing assembly 104 adopts a structure and operating principle similar to that of a conventional press-type pump head, such as those commonly used in shampoo or lotion bottles. During use, upon user actuation of the press-to-dispense head 124, the liquid dispensing pump core 118 performs a pumping action to extract the care product from the bottle body 100 and dispense the care product in a controlled manner, thereby enabling convenient, hygienic, and precise dispensing.

Accordingly, the embodiments of the present application enable one-touch or one-click liquid dispensing, thereby simplifying user operation. With a light press of the press-to-dispense head 124, a predetermined or appropriate amount of care or nursing product can be dispensed, making the dispensing bottle particularly suitable for situations in which rapid and convenient access to care products is required.

Referring to FIGS. 3 and 4, in an embodiment, the bottle cap 102 comprises an outer shell 126 and a connecting seat 128. The outer shell 126 is provided with a connecting port 130 on a side adjacent to the bottle body 100. The connecting tube 122 passes through a side of the outer shell 126 opposite the connecting port 130 and extends to the exterior of the bottle cap 102. The connecting seat 128 is coupled to the connecting port 130 of the outer shell 126, thereby defining a receiving cavity 132 between the outer shell 126 and the connecting seat 128. The receiving cavity 132 accommodates the liquid dispensing pump core 118. The connecting seat 128 is configured to be detachably connected to the bottle body 100.

In an embodiment, the outer shell 126 constitutes the main structural body of the bottle cap 102, and the connecting port 130 formed at a lower portion thereof is configured for engagement with the connecting seat 128. The connecting tube 122 extends through an upper portion of the outer shell 126 and serves as a liquid delivery passage for guiding the care product from the liquid dispensing pump core 118 to the exterior of the bottle cap 102.

The connecting seat 128 is fixedly connected to the connecting port 130 of the outer shell 126, and together they form the enclosed receiving cavity 132. The liquid dispensing pump core 118 is disposed within the receiving cavity 132 to ensure stable positioning and reliable operation. The connecting seat 128 is further configured to connect directly to the bottle body 100, thereby securing the bottle cap 102 to the bottle body 100.

The suction tube 120 extends through the connecting seat 128, with an upper end of the suction tube 120 connected to the liquid dispensing pump core 118 and a lower end extending into the interior of the bottle body 100. The suction tube 120 is configured to draw the care or medical product stored in the bottle body 100 into the liquid dispensing pump core 118 for subsequent dispensing. The evaporation end 114 of the heat-conducting pipe 108 and the heating element 110 are disposed within the receiving cavity 132. The evaporation end 114 is heated by the heating element 110, while the condensation end 116 of the heat-conducting pipe 108 passes through the connecting seat 128 and extends into the bottle body 100, thereby enabling the coolant vapor to release heat within the bottle body 100 and heat the stored medical or care products.

By integrating the liquid dispensing assembly 104 and the heating assembly 106 into the bottle cap 102 through the above-described structural arrangement, the embodiments of the present application achieve a compact configuration that is easy to carry, convenient to operate, and suitable for portable and frequent use.

Referring to FIGS. 2 to 4, in an embodiment, the bottle body 100 includes the bottle mouth 140. The connecting seat 128 comprises a top wall 134, a peripheral wall 136, and a flange 138. The top wall 134 is provided with an opening. The peripheral wall 136 is connected to an edge of the top wall 134 and is configured to surround and engage the bottle mouth 140 of the bottle body 100. The flange 138 is connected to an edge of the peripheral wall 136 opposite the top wall 134 and is configured to connect with the connecting port 130 of the outer shell 126.

The bottle cap 102 further includes a sealing ring 142, which comprises a main body 144 and a sealing portion 146. The main body 144 is mounted within the opening of the top wall 134, and the sealing portion 146 extends from the main body 144 and is clamped between the end faces of the top wall 134 and the bottle mouth 140, thereby forming a fluid- tight seal. The suction tube 120 and the heat-conducting pipe 108 pass through the main body 144 and the bottle mouth 140, ensuring reliable sealing while allowing functional components to extend into the bottle body 100.

In an embodiment, the connecting seat 128 may be formed as a one-piece molded structure, which facilitates manufacturing and enhances overall structural strength. The top wall 134 of the connecting seat 128 is provided with a central opening configured to receive and install the sealing ring 142. The peripheral wall 136 is connected to an edge of the top wall 134 and is configured to engage with the bottle mouth 140 of the bottle body 100, for example, by a threaded connection, thereby allowing the connecting seat 128 to be securely mounted onto the bottle body 100 while also permitting convenient disassembly for refilling or replacing care products. The flange 138 is formed at a lower edge of the peripheral wall 136 and is configured to connect with the connecting port 130 provided at a lower portion of the outer shell 126. The flange 138 enhances the mechanical connection between the connecting seat 128 and the outer shell 126, thereby improving the overall stability and structural integrity of the bottle cap 102.

The sealing ring 142 may likewise be formed as a one-piece molded structure, which simplifies processing and improves structural robustness. The sealing ring 142 includes the main body 144 and the sealing portion 146. The main body 144 is mounted within the opening of the top wall 134, for example, by snap-fitting, thereby fixing and supporting the sealing ring 142 while sealing the receiving cavity 132 of the bottle cap 102. The sealing portion 146 extends from the main body 144 and is clamped between an end face of the top wall 134 and an end face of the bottle mouth 140 of the bottle body 100, thereby forming a reliable fluid-tight seal. This configuration effectively prevents leakage of the care products and inhibits the ingress of external air, moisture, or contaminants into the bottle body 100.

The suction tube 120 and the heat-conducting pipe 108 both extend through the main body 144 of the sealing ring 142 and further pass through the bottle mouth 140, thereby allowing these functional components to smoothly extend from the bottle cap 102 into the interior of the bottle body 100 while maintaining a sealed connection.

Accordingly, the connecting seat 128 in this embodiment provides robust mechanical support and ensures a secure and stable connection between the bottle cap 102 and the bottle body 100, even during handling or transportation. Furthermore, the sealing ring 142 ensures effective sealing performance, thereby maintaining the quality, safety, and hygiene of the care products stored within the bottle body 100.

Referring to FIG. 3 and 4, in an embodiment, the sealing ring 142 further includes a limiting part 148 formed on a side of the main body 144 opposite the sealing portion 146. The limiting part 148 is disposed within the receiving cavity 132. The limiting part 148 is provided with a limiting channel 150 and a limiting groove 152. One end of the suction tube 120 is connected to one end of the liquid dispensing pump core 118 within the limiting channel 150, thereby ensuring accurate alignment and a stable connection between the suction tube 120 and the liquid dispensing pump core 118. The evaporation end 114 of the heat-conducting pipe 108 and the heating element 110 are disposed within the limiting groove 152, such that their positions are reliably constrained, ensuring stable installation and efficient heat transfer.

In an embodiment, opposite ends of the limiting channel 150 of the limiting part 148 are respectively in communication with the receiving cavity 132 of the bottle cap 102 and the main body 144 of the sealing ring 142. The limiting channel 150 is configured to receive and accommodate the upper end of the suction tube 120 and the lower end of the liquid dispensing pump core 118, thereby ensuring accurate axial alignment and a secure connection between the suction tube 120 and the liquid dispensing pump core 118. By virtue of the limiting channel 150, the suction tube 120 can be quickly inserted and reliably coupled to the liquid dispensing pump core 118, which simplifies the assembly process and improves manufacturing efficiency.

The limiting groove 152 of the limiting part 148 is connected to the main body 144 and is configured to receive and position the heating element 110 and the evaporation end 114 of the heat-conducting pipe 108. The limiting groove 152 ensures stable positioning and close contact between the heating element 110 and the evaporation end 114, thereby promoting efficient heat transfer. Moreover, the structural configuration of the limiting groove 152 facilitates rapid and accurate placement of the heating element 110 and the heat-conducting pipe 108 during assembly, reduces the likelihood of installation errors, and provides additional mechanical support, thereby enhancing the overall structural stability of the bottle cap 102.

Accordingly, the embodiments of the present application not only simplify the assembly process but also ensure stable and reliable heating and liquid extraction functions, thereby providing users with a convenient and efficient care product usage experience.

Referring to FIG. 3 and 4, in an embodiment, the liquid dispensing assembly 104 further includes a fixing member 154. The fixing member 154 is connected to an inner wall of the outer shell 126 on a side away from the connecting port 130 and is configured to engage with and secure the liquid dispensing pump core 118.

In an embodiment, a mounting bracket 156 is provided on an upper inner wall of the outer shell 126. The fixing member 154 may be implemented as a clamping or chuck structure connected to the mounting bracket 156. The fixing member 154 is provided with a snap-fit opening or recess, within which the liquid dispensing pump core 118 is snap-fitted and retained.

The fixing member 154 provides mechanical support for the liquid dispensing pump core 118, securing the liquid dispensing pump core 118 within the bottle cap 102 and preventing displacement, loosening, or misalignment during use caused by vibration or external forces. This configuration reduces the risk of functional failure or leakage resulting from the movement of the liquid dispensing pump core 118. Furthermore, the snap-fit design of the fixing member 154 simplifies installation of the liquid dispensing pump core 118, enabling quick and accurate positioning, reducing assembly time, and lowering manufacturing complexity.

Accordingly, the embodiments of the present application not only ensure stable and reliable positioning and operation of the liquid dispensing pump core 118 but also simplify the overall assembly process and improve production efficiency.

Referring to FIG. 3 and 4, in an embodiment, the dispensing bottle further includes a battery 158 and a circuit board 160 disposed within the bottle cap 102. The circuit board 160 is electrically connected to the heating element 110 and the battery 158, thereby enabling electrical power supply and control of the heating assembly 106.

In an embodiment, the battery 158 is arranged within the receiving cavity 132 of the bottle cap 102 and provides electrical power to the heating element 110 and other electrical components of the dispensing bottle. The battery 158 may be selected from various suitable types, such as a rechargeable lithium battery, to support repeated use and long service life.

The circuit board 160 is also disposed within the receiving cavity 132 of the bottle cap 102 and is configured to manage and control the electrical operations of the dispensing bottle. The circuit board 160 is electrically coupled to the heating element 110 and the battery 158 to regulate power delivery to the heating element 110 and to control heating parameters as required. Through the integration of the battery 158 and the circuit board 160 within the bottle cap 102, the dispensing bottle achieves enhanced functionality while maintaining a compact and portable structure.

Referring to FIGS. 1 to 4, in an embodiment, the dispensing bottle further includes a touch key 162 and a charging electrode 164 electrically connected to the circuit board 160. The touch key 162 is arranged on an exterior surface of the bottle cap 102 and is configured to control an operating state of the heating element 110, such as switching the heating assembly 106 on or off or selecting different operating modes. The charging electrode 164 is disposed on or adjacent to the touch key 162 and is configured to receive external electrical power for charging the battery 158.

In an embodiment, the outer shell 126 of the bottle cap 102 is provided with a mounting hole, within which the touch key 162 is arranged to facilitate convenient operation by a user. The touch key 162 is electrically connected to the circuit board 160 and is configured to control an operating state of the heating element 110, such as powering the heating assembly 106 on or off and selecting different operating modes or power levels.

Furthermore, the touch key 162 may be provided with two positioning holes. The charging electrode 164 includes a positive electrode 166 and a negative electrode 168, which are respectively disposed within the positioning holes of the touch key 162. The charging electrode 164 is electrically connected to the circuit board 160 and is configured to receive external electrical power for charging the built-in battery 158.

Accordingly, this embodiment provides an intuitive and simplified user interface through the touch key 162, enabling users to perform various control operations with a light touch, thereby reducing operational complexity. Moreover, by integrating the charging electrode 164 into the touch key 162, spatial efficiency is improved, resulting in a more compact and rational structural layout of the bottle cap 102, while also maintaining a clean, simple, and aesthetically pleasing external appearance.

Referring to FIG. 6, a partial cross-sectional view of the heat-conducting pipe 108 is illustrated, in accordance with an embodiment of the present invention. The cross-sectional view reveals the internal structure of the heat-conducting pipe 108, showing the arrangement of components within the tube. The heat-conducting pipe 108 includes a capillary wick 112 disposed along the inner wall of the tube. The capillary wick 112 is configured to facilitate the return of condensed coolant from the condensation end 116 to the evaporation end 114 through capillary action, thereby enabling continuous heat transfer within the heat-conducting pipe 108. The partial cross-sectional view depicts the heat-conducting pipe 108 in a generally rectangular profile with the capillary wick 112 lining the interior surfaces. The capillary wick 112 appears as a textured or fibrous layer extending along the inner walls of the heat-conducting pipe 108. This configuration allows the coolant contained within the heat-conducting pipe 108 to circulate between the evaporation end 114 and the condensation end 116, supporting efficient phase-change heat transfer for heating the dispensing portion of the care product stored in the bottle body.

In some embodiments, the dispensing bottle may further comprise a temperature sensor disposed within the bottle cap or adjacent to the care product. The temperature sensor may be electrically connected to the circuit board and configured to detect the temperature of the care product or the ambient temperature. The circuit board may include a control unit configured to automatically activate or deactivate the heating element based on the detected temperature relative to a predetermined reference temperature. For example, when the detected temperature is below the reference temperature, the control unit may automatically supply electrical energy from the battery to the heating element to initiate heating. When the detected temperature reaches or exceeds the reference temperature, the control unit may automatically discontinue power supply to the heating element. This automatic temperature control functionality may allow the dispensing bottle to maintain the care product at a desired temperature without requiring manual intervention by the user.

In some embodiments, the coolant disposed inside the heat-conducting tube may be selected from various phase-change fluids suitable for the desired operating temperature range. Suitable coolants may include, but are not limited to, water, alcohol, acetone, or other volatile fluids having relatively low boiling points. The coolant may be selected to be non-toxic and harmless to the human body. In some aspects, the coolant may be selected based on its vapor pressure characteristics at room temperature, such that a high-pressure container is not required. The selection of the coolant may also be based on the latent heat of evaporation, thermal conductivity, and compatibility with the materials of the heat-conducting tube and capillary wick.

In some embodiments, the suction tube may be formed from a thermally conductive material to enhance heat transfer from the condensation end of the heat-conducting tube to the care product flowing within the suction tube. Suitable thermally conductive materials may include metals such as copper, aluminum, stainless steel, or alloys thereof. In some aspects, the outer surface of the suction tube or the condensation end of the heat-conducting tube may be provided with fins, ridges, or other heat transfer enhancement structures configured to increase the heat exchange area and improve heating efficiency.

In some embodiments, the circuit board may be configured to provide multiple selectable heating modes or power levels. For example, the dispensing bottle may include a low power mode, a medium power mode, and a high power mode, which may be selectable by the user through the touch key. In some aspects, the circuit board may store preset temperature profiles corresponding to different care product types, such as a first temperature setting suitable for skincare liquids, a second temperature setting suitable for essential oils, and a third temperature setting suitable for serums. The dispensing bottle may further include a timer function configured to automatically deactivate the heating element after a predetermined heating duration.

In some embodiments, the dispensing bottle may further comprise one or more indicator elements disposed on the bottle cap and electrically connected to the circuit board. The indicator elements may include light-emitting diodes (LEDs) or other light sources configured to provide visual feedback to the user. The indicator elements may be configured to indicate the operating state of the heating element, the battery charge level, or the completion of a heating cycle. In some aspects, the indicator elements may display different colors or blinking patterns corresponding to different operating states. For example, a first color may indicate that the heating element is active, a second color may indicate that the desired temperature has been reached, and a third color may indicate a low battery condition.

In some embodiments, the bottle body may be formed from various materials, including glass, plastic, or combinations thereof. Suitable plastic materials may include polyethylene terephthalate (PET), high-density polyethylene (HDPE), polypropylene (PP), or other polymeric materials. The bottle body may be transparent, translucent, or opaque depending on the desired aesthetic appearance and the light sensitivity of the care product to be stored therein. In some aspects, the bottle body may include ultraviolet (UV) blocking properties to protect light-sensitive care products from degradation.

In some embodiments, thermal insulation may be disposed between the heating assembly and the outer shell of the bottle cap. The thermal insulation may be configured to reduce heat loss from the evaporation end of the heat-conducting tube to the surrounding environment, thereby improving heating efficiency. The thermal insulation may also be configured to prevent the exterior surface of the bottle cap from becoming uncomfortably hot during operation of the heating element, thereby improving user safety and comfort.

In some embodiments, the dispensing bottle may include one or more safety features. The circuit board may be configured to automatically deactivate the heating element after a predetermined time period to prevent overheating or excessive energy consumption. The dispensing bottle may further include overheat protection, wherein the circuit board is configured to deactivate the heating element if the detected temperature exceeds a predetermined safety threshold. In some aspects, the circuit board may be configured to provide a low battery warning through the indicator elements or to automatically deactivate the heating element when the battery charge level falls below a predetermined minimum level. The dispensing bottle may further include a child-lock functionality configured to prevent unintended activation of the heating element.

In some embodiments, the dispensing bottle may include wireless charging capability in addition to or as an alternative to the charging electrodes. An inductive charging coil may be disposed within the bottle cap and electrically connected to the circuit board and the battery. The inductive charging coil may be configured to receive electrical energy from an external wireless charging pad or station through electromagnetic induction, thereby enabling contactless charging of the battery.

In some embodiments, the dispensing assembly may be configured to provide adjustable dispensing volume control. The dispensing pump core or the press-to-dispense head may be configured to dispense different predetermined volumes of the care product per actuation. In some aspects, the dispensing volume may be adjustable by the user through a mechanical adjustment mechanism or through electronic control via the circuit board and touch key.

In some embodiments, the bottle cap assembly, including the dispensing assembly and the heating assembly, may be configured to be compatible with multiple interchangeable bottle bodies. The bottle bodies may have different sizes, capacities, or configurations while maintaining a standardized bottle mouth dimension for engagement with the connecting seat of the bottle cap. This interchangeable configuration may allow users to refill or replace the bottle body while retaining the same bottle cap assembly, thereby reducing waste and improving convenience.

In some embodiments, the circuit board may store preset temperature profiles suitable for different types of care products. For example, a temperature range of approximately 35°C to 45°C may be suitable for skincare liquids and serums, while a temperature range of approximately 40°C to 50°C may be suitable for essential oils or massage oils. The user may select the appropriate temperature profile through the touch key based on the type of care product stored in the bottle body. The circuit board may be configured to control the heating element to achieve and maintain the selected target temperature.

Additionally, the bottle cap 102 further comprises a phototherapy element integrated on the outer shell 126. The phototherapy element is configured to emit therapeutic light toward the user’s skin and may be electrically connected to the circuit board 160, powered by the battery 158. The phototherapy element may be selectively activated through the touch key 162 and may operate independently of, or in coordination with, the liquid dispensing assembly 104 and the heating assembly 106.

After the care or cosmetic product is dispensed from the bottle body 100 and applied to the user’s skin, the outer shell 126 of the bottle cap 102 may be brought into contact with or positioned adjacent to the treated skin area, allowing the phototherapy element to provide phototherapy treatment directly to the skin. This arrangement enables phototherapy to be performed immediately after product application, which can enhance the absorption and effectiveness of the applied product. By integrating the phototherapy element into the bottle cap 102, the dispensing bottle provides a compact, multifunctional structure that combines liquid dispensing, heating, and phototherapy functions in a single device.

In some embodiments, the phototherapy element may be disposed on an end surface, a side surface, or an adjacent region of the outer casing of the bottle cap. The phototherapy element may be positioned adjacent to the press-to-dispense head or on a portion of the outer casing configured to contact or be positioned near the user's skin during phototherapy treatment. The phototherapy element may comprise one or more light-emitting diodes (LEDs), organic LEDs (OLEDs), or other suitable light-emitting devices. In some aspects, the phototherapy element may be configured to emit light at wavelengths suitable for skin treatment, such as red light in the range of approximately 620 nm to 700 nm for collagen stimulation and skin rejuvenation, blue light in the range of approximately 415 nm to 470 nm for antibacterial treatment and acne reduction, or near-infrared light in the range of approximately 700 nm to 1000 nm for deeper tissue penetration and enhanced absorption of the care product. The phototherapy element may be recessed within the outer casing or covered by a transparent or translucent window to protect the light-emitting device while allowing light transmission. In some aspects, a light guide or diffuser may be disposed adjacent to the phototherapy element to distribute the emitted light more uniformly over the treatment area. The phototherapy element may be electrically connected to the circuit board and powered by the battery, and may be controlled via the touch key to provide multiple intensity levels or treatment modes. The phototherapy element may operate independently of the heating assembly or may be configured to operate in coordination with the heating and dispensing functions to provide a combined treatment regimen.

In an embodiment, the dispensing bottle may further comprise a phototherapy element integrated within the dispensing bottle, such as within the bottle cap 102 and/or adjacent to the liquid dispensing assembly 104. The phototherapy element is configured to emit therapeutic light toward the care product before dispensing. When activated, the phototherapy element may irradiate the care product stored in the bottle body 100 or flowing through the liquid dispensing assembly 104, thereby performing a pre-treatment process before the care product is dispensed.

The pre-treatment provided by the phototherapy element may be used to reduce contamination, inhibit microbial growth, or otherwise improve the quality, safety, or stability of the care product before use. By integrating the phototherapy element within the dispensing bottle, the care product can be treated immediately before dispensing without requiring separate sterilization equipment or additional handling steps. This configuration enhances hygiene and reliability of the dispensing process while maintaining a compact and integrated structure of the dispensing bottle.

In some embodiments, the dispensing bottle may further comprise a vibration element or massage element disposed within the bottle cap. The vibration element may be implemented as a vibration motor, such as an eccentric rotating mass (ERM) motor or a linear resonant actuator (LRA), disposed within the outer casing or adjacent to the press-to-dispense head. The vibration element may be electrically connected to the circuit board and powered by the battery. The vibration element may be configured to provide massage stimulation to the user's skin during or after application of the care product, thereby enhancing absorption of the care product and promoting blood circulation. The vibration element may be activated through the touch key and may provide multiple vibration patterns or intensity levels selectable by the user. In some aspects, the vibration element may be disposed on a contact surface of the outer casing configured to contact the user's skin during massage treatment. The vibration element may operate independently of the heating assembly and phototherapy element, or may be configured to operate in coordination with the heating and dispensing functions to provide a combined treatment regimen.

In some embodiments, the dispensing bottle may further comprise one or more microcurrent electrodes disposed on an exterior surface of the bottle cap. The microcurrent electrodes may be configured as paired electrodes, conductive surfaces, or conductive coatings disposed on the outer casing. Suitable electrode materials may include stainless steel, gold-plated metal, titanium, or conductive polymers. The microcurrent electrodes may be positioned on a portion of the outer casing configured to contact the user's skin during treatment. The microcurrent electrodes may be electrically connected to the circuit board, which may include a microcurrent generator configured to deliver low-level electrical current in the microampere range to the user's skin. The microcurrent therapy may be configured to enhance absorption of the care product, stimulate facial muscles, and promote collagen production. The circuit board may include safety features such as current-limiting circuitry and skin contact detection to ensure safe operation. The microcurrent electrodes may provide multiple intensity levels selectable by the user through the touch key. The microcurrent electrodes may operate independently of the heating assembly or may be configured to operate in coordination with the heating, dispensing, and phototherapy functions.

In some embodiments, the dispensing bottle may further comprise a cooling element disposed within the bottle cap for providing optional cooling therapy. The cooling element may be implemented as a thermoelectric device (such as a Peltier element), a heat sink, or a cooling plate disposed within or on the outer casing. The cooling element may be positioned on a contact surface of the outer casing configured to contact the user's skin during cooling treatment. The cooling element may be electrically connected to the circuit board and powered by the battery. The cooling element may be configured to provide a cooling sensation to the user's skin, reduce puffiness, soothe irritated skin, or constrict pores after application of the care product. In some aspects, the dispensing bottle may be configured to operate in a dual-mode configuration, wherein the heating assembly provides heating of the care product within the bottle body, and the cooling element provides cooling therapy to the user's skin after product application. The cooling element may be activated through the touch key and may provide multiple cooling intensity levels. Temperature control of the cooling element may be managed by the circuit board based on user selection or detected skin temperature.

In some embodiments, the dispensing bottle may further comprise an ultrasonic transducer disposed within the bottle cap. The ultrasonic transducer may be positioned on the outer casing or on a contact surface configured to contact the user's skin during treatment. The ultrasonic transducer may be configured to generate ultrasonic vibrations at frequencies suitable for skincare applications, such as frequencies in the range of approximately 1 MHz to 3 MHz for facial treatment. The ultrasonic transducer may be electrically connected to the circuit board, which may include an ultrasonic driver circuit configured to control the frequency and intensity of the ultrasonic output. The ultrasonic vibrations may be configured to enhance penetration of the care product into the user's skin, promote blood circulation, and provide deep cleansing effects. In some aspects, the applied care product may serve as a coupling medium between the ultrasonic transducer and the user's skin. The ultrasonic transducer may be activated through the touch key and may provide multiple operating modes or intensity levels. The ultrasonic transducer may operate independently of the heating assembly or may be configured to operate in coordination with the heating, dispensing, and phototherapy functions.

In some embodiments, the dispensing bottle may comprise multiple stimulation elements configured to operate in combination. For example, the dispensing bottle may include a combination of the heating assembly and the phototherapy element, a combination of the heating assembly and the vibration element, a combination of the phototherapy element and the microcurrent electrodes, or other combinations of stimulation elements. The circuit board may be configured to control multiple stimulation elements simultaneously or sequentially according to a predetermined treatment program. In some aspects, the circuit board may store preset treatment programs that combine dispensing of the care product, heating of the care product, and activation of one or more stimulation elements in a coordinated sequence. The user may select from multiple treatment modes through the touch key, wherein each treatment mode activates a different combination of stimulation elements. This multi-modal approach may provide enhanced therapeutic or cosmetic benefits compared to single-mode operation, and may allow the user to customize the treatment regimen based on individual preferences or skincare needs.

The present invention provides a dispensing bottle that integrates the liquid dispensing assembly and the heating assembly into the bottle cap, thereby enabling efficient heating and controlled dispensing of care products stored in the bottle body. The structural arrangement of the heat-conducting pipe, heating element, liquid dispensing pump core, and sealing components ensures stable operation, rapid heat transfer, and reliable sealing performance. The integration of the battery, circuit board, touch key, and charging electrode further enhances portability and ease of use. As a result, the dispensing bottle enhances user convenience, reduces waiting time, and overcomes the limitations associated with conventional whole-bottle heating and dispensing methods, while maintaining a compact, practical, and hygienic design suitable for repeated use and portability.

The dispensing bottle of the present invention is suitable for industrial manufacture and application in the field of care and medical products. The dispensing bottle can be mass-produced using conventional molding, assembly, and electronic integration processes, and is applicable for storing, heating, and dispensing liquid care products such as medical products, nursing products, and personal care liquids. The integrated liquid dispensing assembly and heating assembly enable efficient operation in consumer, medical, and nursing product industries. Owing to its compact structure, reliable sealing, and integrated heating and dispensing functions, the dispensing bottle is suitable for use in personal care product manufacturing, medical nursing equipment production, and related commercial and industrial applications.

Various modifications to these embodiments are apparent to those skilled in the art from the description and the accompanying drawings. The principles associated with the various embodiments described herein may be applied to other embodiments. Therefore, the description is not intended to be limited to the embodiments shown along with the accompanying drawings but is to provide the broadest scope consistent with the principles and the novel and inventive features disclosed or suggested herein. Accordingly, the invention is anticipated to hold on to all other such alternatives, modifications, and variations that fall within the scope of the present invention and appended claims.

1. A dispensing bottle with an integrated heating assembly for heating and dispensing a care product, comprising:
a bottle body configured to store a care product;
a bottle cap connected to the bottle body;
a dispensing assembly disposed on the bottle cap and configured to dispense the care product from the bottle body;
a heating assembly including a heat-conducting tube and a heating element, wherein:
an inner wall of the heat-conducting tube is provided with a capillary wick;
a coolant is disposed inside the heat-conducting tube;
the heat-conducting tube has an evaporation end and a condensation end;
the evaporation end is connected to a side of the bottle cap adjacent to the bottle body;
the condensation end extends into the bottle body;
the heating element is disposed on the evaporation end; and
wherein the heating assembly is configured to heat a dispensing portion of the care product proximate to the condensation end by enabling rapid and continuous heat transfer through evaporation and condensation.

2. The dispensing bottle of claim 1, wherein the condensation end is spiral-shaped and the heating element is wound around the evaporation end.

3. The dispensing bottle of claim 2, wherein the dispensing assembly includes a suction tube extending into the bottle body, and the condensation end is wound around the suction tube.

4. The dispensing bottle of claim 1, wherein the dispensing assembly comprises:
a dispensing pump core disposed inside the bottle cap;
a suction tube having one end connected to one end of the dispensing pump core and another end passing through the bottle cap on a side adjacent to the bottle body into the bottle body;
a connecting tube having one end connected to another end of the dispensing pump core and another end passing through the bottle cap on a side away from the bottle body to an outside of the bottle cap; and
a press-to-dispense head connected to the other end of the connecting tube.

5. The dispensing bottle of claim 4, wherein the bottle cap comprises:
an outer casing having a connection port on a side adjacent to the bottle body, wherein the connecting tube passes through the outer casing on a side away from the connection port; and
a connecting seat connected to the connection port to form a receiving cavity between the outer casing and the connecting seat, wherein the receiving cavity accommodates the dispensing pump core, and the connecting seat is configured to connect to the bottle body; and
wherein the suction tube passes through the connecting seat, the evaporation end is disposed in the receiving cavity, and the condensation end passes through the connecting seat into the bottle body.

6. The dispensing bottle of claim 5, wherein:
the bottle body is provided with a bottle mouth;
the connecting seat includes a top wall having an opening, a peripheral wall connected to an edge of the top wall and configured to surround and connect to the bottle mouth, and a flange connected to an edge of the peripheral wall away from the top wall and configured to connect to the connection port; and
the bottle cap further includes a sealing ring comprising a main body connected to the opening and a sealing part connected to the main body and configured to clamp between the top wall and an end face of the bottle mouth, wherein the suction tube and the heat-conducting tube pass through the main body and the bottle mouth.

7. The dispensing bottle of claim 6, wherein the sealing ring further includes a limiting part connected to a side of the main body facing away from the sealing part, the limiting part being disposed in the receiving cavity, the limiting part being provided with a limiting channel and a limiting groove, wherein one end of the suction tube is connected to one end of the dispensing pump core in the limiting channel, and the heating element and the evaporation end are disposed in the limiting groove.

8. The dispensing bottle of claim 5, wherein the dispensing assembly further includes a fixing member connected to an inner wall of the outer casing on a side away from the connection port and connected to the dispensing pump core.

9. The dispensing bottle of claim 1, further comprising a battery and a circuit board disposed in the bottle cap, the circuit board being electrically connected to the heating element and the battery.

10. The dispensing bottle of claim 9, further comprising a touch key and a charging electrode electrically connected to the circuit board, wherein the touch key is disposed on the bottle cap and configured to control an operating state of the heating element, and the charging electrode is disposed on the touch key and configured to charge the battery.

11. The dispensing bottle of claim 1, further comprising a temperature sensor configured to automatically activate or deactivate the heating element based on the detected temperature relative to a predetermined reference temperature.

12. A bottle cap with an integrated heating assembly and dispensing assembly for attachment to a bottle body storing a care product, comprising:
an outer casing having a connection port on a side adjacent to the bottle body, and a connecting seat connected to the connection port to form a receiving cavity between the outer casing and the connecting seat;
a dispensing assembly including a dispensing pump core disposed in the receiving cavity, a suction tube having one end connected to the dispensing pump core and another end extending through the connecting seat into the bottle body, a connecting tube having one end connected to the dispensing pump core and another end extending through the outer casing to an outside of the bottle cap, and a press-to-dispense head connected to the connecting tube;
a heating assembly including a heat-conducting tube having an evaporation end disposed in the receiving cavity and a condensation end extending through the connecting seat into the bottle body, wherein an inner wall of the heat-conducting tube is provided with a capillary wick and a coolant is disposed inside the heat-conducting tube, and a heating element disposed on the evaporation end;
wherein the heating assembly is configured to heat a dispensing portion of the care product proximate to the condensation end by enabling rapid and continuous heat transfer through evaporation and condensation; and
wherein the bottle cap is configured to connect to a bottle body storing the care product.

13. The bottle cap of claim 12, wherein the condensation end is spiral-shaped and wound around the suction tube.

14. The bottle cap of claim 13, wherein the heating element is spiral-shaped and wound around the evaporation end.

15. The bottle cap of claim 12, wherein:
the connecting seat includes a top wall having an opening, a peripheral wall connected to an edge of the top wall and configured to surround and connect to the bottle mouth, and a flange connected to an edge of the peripheral wall away from the top wall and configured to connect to the connection port; and
the bottle cap further includes a sealing ring comprising a main body connected to the opening and a sealing part connected to the main body and configured to clamp between the top wall and an end face of the bottle mouth, wherein the suction tube and the heat-conducting tube pass through the main body and the bottle mouth.

16. The bottle cap of claim 15, wherein the sealing ring further includes a limiting part connected to a side of the main body facing away from the sealing part, the limiting part being disposed in the receiving cavity and provided with a limiting channel and a limiting groove, wherein one end of the suction tube is connected to one end of the dispensing pump core in the limiting channel, and the heating element and the evaporation end are disposed in the limiting groove.

17. The bottle cap of claim 12, further comprising a phototherapy unit configured to provide phototherapy to a user.

18. A method of dispensing and heating a care product using a dispensing bottle having a heat-conducting tube with a capillary wick, comprising:
storing the care product in a bottle body of a dispensing bottle;
activating a heating element disposed on an evaporation end of a heat-conducting tube, wherein the heat-conducting tube includes a capillary wick on an inner wall thereof and contains a coolant, and wherein a condensation end of the heat-conducting tube extends into the bottle body;
transferring heat from the evaporation end to the condensation end via evaporation and condensation of the coolant within the heat-conducting tube to heat the care product in the bottle body;
dispensing the care product through a dispensing assembly disposed on a bottle cap connected to the bottle body.

19. The method of claim 18, wherein the condensation end of the heat-conducting tube is spiral-shaped and wound around a suction tube of the dispensing assembly that extends into the bottle body.

20. The method of claim 19, wherein transferring heat from the evaporation end to the condensation end comprises:
evaporating the coolant at the evaporation end responsive to heat from the heating element;
moving the evaporated coolant toward the condensation end;
condensing the evaporated coolant at the condensation end to release heat to the care product; and
returning the condensed coolant to the evaporation end via capillary action of the capillary wick.
